(19) United States
(12) Patent Application Publication
(10) Pub. No.: US 2008/0277227 A1
(43) Pub. Date: Nov. 13, 2008

(54) Torque converter with anti-rattle and cooling flow arrangement

(75) Inventors: Jonathan G. Jameson, Canton, OH (US); Yang Liang, Waterloo, IA (US); Steven Olsen, Wooster, OH (US); Michael G. Swank, Shreve, OH (US); Kevin Parks, Wooster, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/150,842

(22) Filed: May 1, 2008

Related U.S. Application Data
(60) Provisional application No. 60/958,407, filed on Jul. 5, 2007.
(60) Provisional application No. 60/928,437, filed on May 9, 2007.

(51) Int. Cl. F16D 33/00

(52) U.S. Cl. 192/3.33

(57) ABSTRACT

A torque converter including: a carrier for a torque converter clutch, the carrier rotationally connected to a turbine shell; an apply chamber for the clutch; and a first pressure chamber in fluid communication with a second pressure chamber and a torus. Pressure in the apply chamber is controlled independent of pressure in the first and second pressure chambers. A torque converter including: a turbine hub rotationally connected to a turbine shell and a cover plate for a damper assembly; and a clutch arranged to rotationally connect the turbine hub to a cover. A torque converter including: a first cover plate for a damper assembly, the first cover plate rotationally connected to a turbine hub and a torque converter clutch; and a second cover plate for a damper assembly, the second cover rotationally connected to the turbine hub and the torque converter clutch.

### CROSS-REFERENCE TO RELATED APPLICATIONS

This application claims the benefit under 35 U.S.C. §119(e) of U.S. Provisional Application No. 60/958,407 filed Jul. 5, 2007 and U.S. Provisional Application No. 60/928,437 filed on May 9, 2007, which applications are incorporated herein by reference.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to a torque converter with a torque converter clutch providing torque to a turbine hub during lock-up mode while minimizing frictional losses during torque converter mode and providing improved cooling flow.

### BACKGROUND OF THE INVENTION

FIG. 1 illustrates a general block diagram showing the relationship of the engine 7, torque converter 10, transmission 8, and differential/axle assembly 9 in a typical vehicle. It is well known that a torque converter is used to transmit torque from an engine to a transmission of a motor vehicle.

The three main components of the torque converter are the pump 37, turbine 38, and stator 39. The torque converter becomes a sealed chamber when the pump is welded to cover 11. The cover is connected to flexplate 41 which is, in turn, bolted to crankshaft 42 of engine 7. The cover can be connected to the flexplate using lugs or studs welded to the cover. The welded connection between the pump and cover transmits engine torque to the pump. Therefore, the pump always rotates at engine speed. The function of the pump is to use this rotational motion to propel the fluid radially outward and axially towards the turbine. Therefore, the pump is a centrifugal pump propelling fluid from a small radial inlet to a large radial outlet, increasing the energy in the fluid. Pressure to engage transmission clutches and the torque converter clutch is supplied by an additional pump in the transmission that is driven by the pump hub.

In torque converter 10 a fluid circuit is created by the pump (sometimes called an impeller), the turbine, and the stator (sometimes called a reactor). The fluid circuit allows the engine to continue rotating when the vehicle is stopped, and accelerate the vehicle when desired by a driver. The torque converter supplements engine torque through torque ratio, similar to a gear reduction. Torque ratio is the ratio of output torque to input torque. Torque ratio is highest at low or no turbine rotational speed (also called stall). Stall torque ratios are typically within a range of 1.8-2.2. This means that the output torque of the torque converter is 1.8-2.2 times greater than the input torque. Output speed, however, is much lower than input speed, because the turbine is connected to the output and it is not rotating, but the input is rotating at engine speed.

Turbine 38 uses the fluid energy it receives from pump 37 to propel the vehicle. Turbine shell 22 is connected to turbine hub 19. Turbine hub 19 uses a spline connection to transmit turbine torque to transmission input shaft 43. The input shaft is connected to the wheels of the vehicle through gears and shafts in transmission 8 and axle differential 9. The force of the fluid impacting the turbine blades is output from the turbine as torque. Axial thrust bearings 31 support the components from axial forces imparted by the fluid. When output torque is sufficient to overcome the inertia of the vehicle at rest, the vehicle begins to move.

After the fluid energy is converted to torque by the turbine, there is still some energy left in the fluid. The fluid exiting from small radial outlet 44 would ordinarily enter the pump in such a manner as to oppose the rotation of the pump. Stator 39 is used to redirect the fluid to help accelerate the pump, thereby increasing torque ratio. Stator 39 is connected to stator shaft 45 through one-way clutch 46. The stator shaft is connected to transmission housing 47 and does not rotate. One-way clutch 46 prevents stator 39 from rotating at low speed ratios (where the pump is spinning faster than the turbine). Fluid entering stator 39 from turbine outlet 44 is turned by stator blades 48 to enter pump 37 in the direction of rotation.

The blade inlet and exit angles, the pump and turbine shell shapes, and the overall diameter of the torque converter influence its performance. Design parameters include the torque ratio, efficiency, and ability of the torque converter to absorb engine torque without allowing the engine to “run away.” This occurs if the torque converter is too small and the pump can't slow the engine.

At low speed ratios, the torque converter works well to allow the engine to rotate while the vehicle is stationary, and to supplement engine torque for increased performance. At speed ratios less than 1, the torque converter is less than 100% efficient. The torque ratio of the torque converter gradually reduces from a high of about 1.8 to 2.2, to a torque ratio of about 1 as the turbine rotational speed approaches the pump rotational speed. The speed ratio when the torque ratio reaches 1 is called the coupling point. At this point, the fluid entering the stator no longer needs redirected, and the one way clutch in the stator allows it to rotate in the same direction as the pump and turbine. Because the stator is not redirecting the fluid, torque output from the torque converter is the same as torque input. The entire fluid circuit will rotate as a unit.

Peak torque converter efficiency is limited to 92-93% based on losses in the fluid. Therefore torque converter clutch 49 is employed to mechanically connect the torque converter input to the output, improving efficiency to 100%. Clutch piston plate 17 is hydraulically applied when commanded by the transmission controller. Piston plate 17 is sealed to turbine hub 19 at its inner diameter by o-ring 18 and to cover 11 at its outer diameter by friction material ring 51. These seals create a pressure chamber and force piston plate 17 into engagement with cover 11. This mechanical connection bypasses the torque converter fluid circuit.

The mechanical connection of torque converter clutch 49 transmits many more engine torsional fluctuations to the drivetrain. As the drivetrain is basically a spring-mass system, torsional fluctuations from the engine can excite natural frequencies of the system. A damper is employed to shift the drivetrain natural frequencies out of the driving range. The damper includes springs 15 in series with engine 7 and transmission 8 to lower the effective spring rate of the system, thereby lowering the natural frequency.

Torque converter clutch 49 generally comprises four components: piston plate 17, cover plates 12 and 16, springs 15, and flange 13. Cover plates 12 and 16 transmit torque from piston plate 17 to compression springs 15. Cover plate wings 52 are formed around springs 15 for axial retention. Torque from piston plate 17 is transmitted to cover plates 12 and 16 through a riveted connection. Cover plates 12 and 16 impart torque to compression springs 15 by contact with an edge of a spring window. Both cover plates work in combination to support the spring on both sides of the spring center axis. Spring force is transmitted to flange 13 by contact with a flange spring window edge. Sometimes the flange also has a rotational tab or slot which engages a portion of the cover plate to prevent over-compression of the springs during high torque events. Torque from flange 13 is transmitted to turbine hub 19 and into transmission input shaft 43.

Energy absorption can be accomplished through friction, sometimes called hysteresis, if desired. Hysteresis includes friction from windup and unwinding of the damper plates, so it is twice the actual friction torque. The hysteresis package generally consists of diaphragm (or Belleville) spring 14 which is placed between flange 13 and one of cover plates 16 to urge flange 13 into contact with the other cover plate 12. By controlling the amount of force exerted by diaphragm spring 14, the amount of friction torque can also be controlled. Typical hysteresis values are in the range of 10-30 Nm.

In lock-up mode for the torque converter, there is little or no torque applied to turbine hub 19. At the same time, cover plates 16 are receiving engine torque through the damper. Thus, there is intermittent contact between cover plate 16 and the turbine hub at the at the spline connection between the plate and the hub, resulting in undesirable vibration and noise. Alternately stated, the cover plate ‘bangs’ against the turbine hub at the spline connection due to fluctuations in the engine torque, causing the vibration and noise noted above. Commonly-owned U.S. Provisional Patent Application No. 60/816,932, filed Jun. 28, 2006 discloses a means for preventing the vibration and noise noted above during operation of a torque converter during torque converter mode. However, it would be desirable to further reduce drag in the torque converter clutch during the operation in torque converter mode.

Therefore, there is a long-felt to provide a torque converter with a means of preventing rattle and reducing drag in a torque converter clutch during operation in torque converter mode while improving cooling flow.

### BRIEF SUMMARY OF THE INVENTION

The present invention broadly comprises a torque converter including: a carrier for a torque converter clutch, the carrier rotationally connected to a turbine shell; an apply chamber for the clutch; and a first pressure chamber in fluid communication with a second pressure chamber and a torus. Pressure in the apply chamber is controlled independent of pressure in the first and second pressure chambers. In some aspects, the carrier is fixedly secured to the turbine shell. In some aspects, the torque converter includes a turbine hub rotationally connected to the turbine shell. In some aspects, the torque converter includes a damper with a cover plate and the clutch includes a friction plate rotationally connected to the cover plate. In some aspects, the cover plate is rotationally connected to the turbine hub. When the clutch is closed, a first torque transfer path is formed from the clutch to the turbine hub through the carrier and the turbine shell and a second torque transfer path is formed from the clutch to the turbine hub through the cover plate. In some aspects, the torque converter includes a cover arranged to transmit torque to the clutch and when the clutch is closed, substantially all of the torque is transferred from the clutch to the turbine hub through the turbine shell. In some aspects, the torque converter includes a damper with a cover plate rotationally connected to the turbine hub.

The present invention also broadly comprises a torque converter including: a turbine hub rotationally connected to a turbine shell and a cover plate for a damper assembly; and a hub clutch arranged to rotationally connect the turbine hub to a cover. In some aspects, the torque converter includes a torque converter clutch rotationally connected to the cover plate. In some aspects, the hub cover is rotationally connected to the torque converter clutch and when the torque converter clutch is closed, the hub clutch is arranged to close, a first torque path is formed from the cover through the hub clutch to the turbine hub and a second torque path is formed from the cover to the cover plate through the torque converter clutch. In some aspects, the torque converter includes a damper hub rotationally connected to the damper assembly, the damper hub including at least one opening and the turbine hub includes at least one portion disposed in the at least one opening and having a distal end arranged to engage the hub clutch. In some aspects, the torque converter includes a cover and the clutch includes a drive plate rotationally connected to the cover and the piston plate is arranged to urge the drive plate toward the turbine hub to rotationally connect the cover and the turbine hub. In some aspects, the torque converter includes an apply chamber for a torque converter clutch; and a first pressure chamber in fluid communication with a second pressure chamber and a torus. Pressure in the apply chamber is controlled independent of pressure in the first and second pressure chambers.

The present invention further broadly comprises a torque converter including: a first cover plate for a damper assembly, the first cover plate rotationally connected to a turbine hub and a torque converter clutch; and a second cover plate for a damper assembly, the second cover rotationally connected to the turbine hub and the torque converter clutch. In some aspects, the clutch includes a first friction plate rotationally connected to the first cover plate and a second friction plate rotationally connected to the second cover plate. In some aspects, the first cover plate is at least partially rotationally independent of the second cover plate. In some aspects, the torque converter includes a cover and a damper hub rotationally connected to the damper assembly, the damper hub including at least one opening, the turbine hub includes at least one portion disposed in the at least one opening and having a distal portion extending axially beyond the damper hub toward the cover and the second cover plate is rotationally connected to the distal portion.

In some aspects, the torque converter includes a turbine shell and in torque converter mode for the torque converter, the turbine shell is arranged to transmit torque to the damper through the turbine hub and the first cover plate. In some aspects, the torque converter includes a cover rotationally connected to the torque converter clutch and when the torque converter clutch is closed, a first torque path is formed from the cover to the turbine hub through the torque converter clutch and the first cover plate and a second torque path is formed from the cover to the turbine hub through the torque converter clutch and the second cover plate. In some aspects, the torque converter includes an apply chamber for a torque converter clutch; and a first pressure chamber in fluid communication with a second pressure chamber and a torus, wherein pressure in the apply chamber is controlled independent of pressure in the first and second pressure chambers.

The present invention broadly comprises a torque converter including: a turbine hub; a cover plate for a damper assembly, the cover plate rotationally connected to the turbine hub; and a friction plate for a torque converter clutch, the friction plate rotationally connected to the turbine hub. In torque converter mode for the torque converter, a turbine shell is arranged to transmit torque to the damper through the turbine hub and the cover plate and when the clutch is closed, the clutch is arranged to transmit torque to the damper through the friction plate, the

The present invention also broadly comprises a torque converter including: a carrier for a torque converter clutch; first, second, and third clutch plates rotationally connected to the carrier; a first resilient element engaged with the first and second clutch plates and arranged to urge the first and second clutch plates in opposite circumferential directions; and a second resilient element engaged with the second and third clutch plates and arranged to urge the second and third clutch plates in opposite circumferential directions. In some aspects, the carrier includes a spline, the first, second, and third clutch plates are rotationally connected to the spline, and the first and second resilient elements are arranged to urge the first, second, and third clutch plates against the spline.

The present invention further broadly comprises a torque converter including: a first clutch plate for a torque converter clutch, the first clutch plate rotationally connected to a cover; and a second clutch plate for the torque converter clutch, the second clutch plate rotationally connected to a backing plate. In some aspects, the torque converter includes a turbine hub rotationally connected to a cover plate for a damper and a turbine shell and the torque converter clutch includes a third clutch plate rotationally connected to the turbine hub. In some aspects, the torque converter includes a turbine hub rotationally connected to a turbine shell and the torque converter clutch includes a fourth clutch plate rotationally connected to the turbine hub. In some aspects, the torque converter includes a plate, a connector plate, and a cover plate for a damper, the clutch includes a fifth clutch plate, the plate is rotationally connected to the fourth clutch plate and the turbine hub and the connection plate is rotationally connected to the plate, the cover plate and the fifth clutch plate. In some aspects, the torque converter includes an apply chamber for the torque converter clutch; and a first pressure chamber in fluid communication with a second pressure chamber and a torus. The pressure in the apply chamber is controlled independent of pressure in the first and second pressure chambers.

It is a general object of the present invention to provide a torque converter with a means of preventing rattle and reducing drag in a torque converter clutch during operation in torque converter mode, while also improving cooling flow.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a general block diagram illustration of power flow in a motor vehicle, intended to help explain the relationship and function of a torque converter in the drive train thereof;

FIG. 2 is a cross-sectional view of a prior art torque converter, shown secured to an engine of a motor vehicle;

FIG. 3 is a left view of the torque converter shown in FIG. 2, taken generally along line 3-3 in FIG. 2;

FIG. 4 is a cross-sectional view of the torque converter shown in FIGS. 2 and 3, taken generally along line 4-4 in FIG. 3;

FIG. 5 is a first exploded view of the torque converter shown in FIG. 2, as shown from the perspective of one viewing the exploded torque converter from the left;

FIG. 6 is a second exploded view of the torque converter shown in FIG. 2, as shown from the perspective of one viewing the exploded torque converter from the right;

FIG. 7A is a perspective view of a cylindrical coordinate system demonstrating spatial terminology used in the present application;

FIG. 7B is a perspective view of an object in the cylindrical coordinate system of FIG. 7A demonstrating spatial terminology used in the present application;

FIG. 8 is a partial cross-sectional view of a present invention torque converter with a torque converter clutch rotationally connected to a turbine shell.

FIG. 9 is a partial cross-sectional view of a present invention torque converter with a turbine rotationally connected to a clutch through friction plates and a carrier;

FIG. 10 is a partial cross-sectional view of a present invention torque converter with a hub clutch;

FIG. 11 is a partial cross-sectional view of a present invention torque converter with a dual cover plate connection between a torque converter clutch and a damper;

FIG. 11A is a detail view of an alternative clutch plate applicable to the torque converter shown in FIG. 11;

FIG. 12 is a partial perspective view of a present invention torque converter anti-rattle connection;

FIG. 13 is a partial cross-sectional view of a present invention torque converter with an anti-rattle plate;

FIG. 14 is a partial cross-sectional view of a present invention torque converter with a friction plate connected to a backing plate; and,

FIG. 15 is a partial cross-sectional view of a present invention torque converter with a friction plate connected to a backing plate.

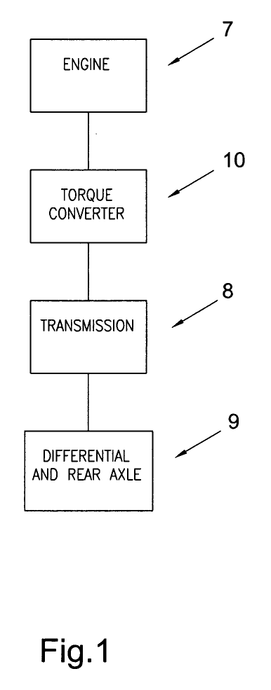

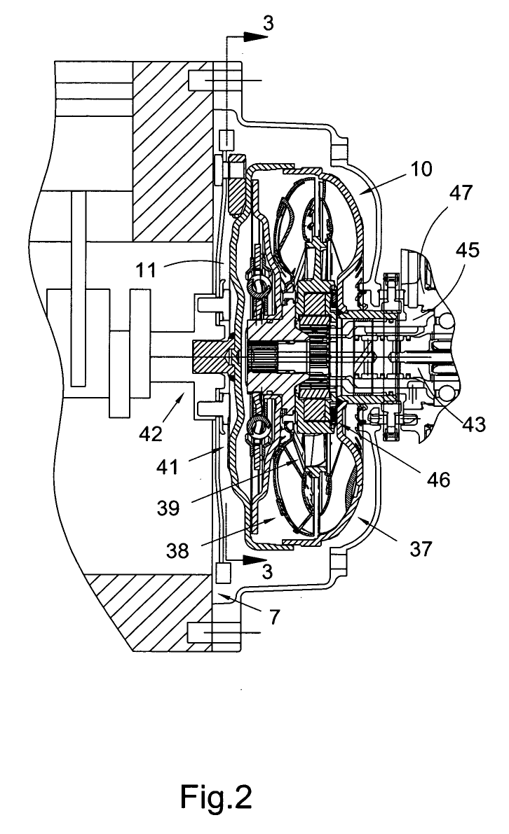

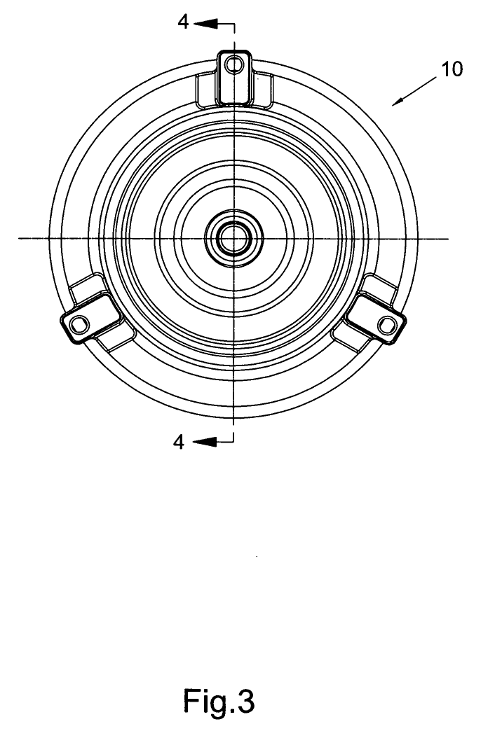

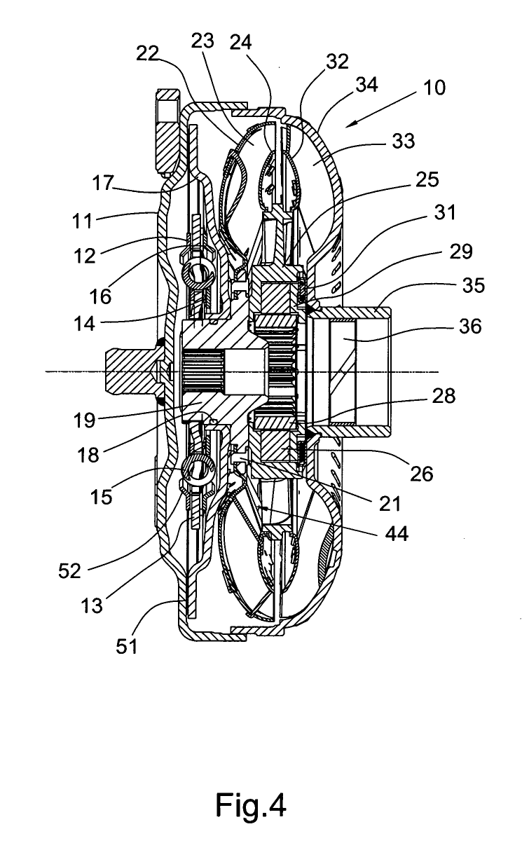

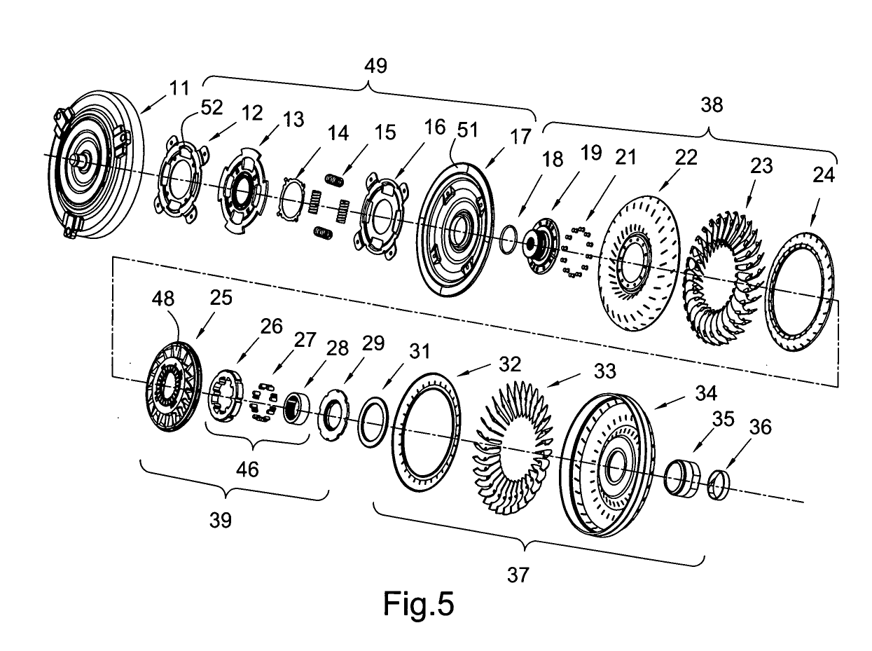

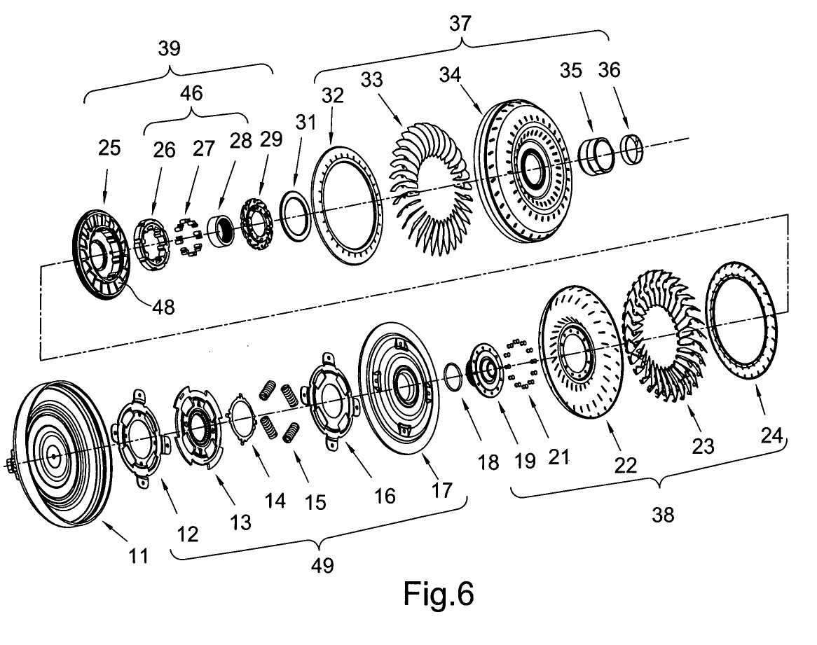

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

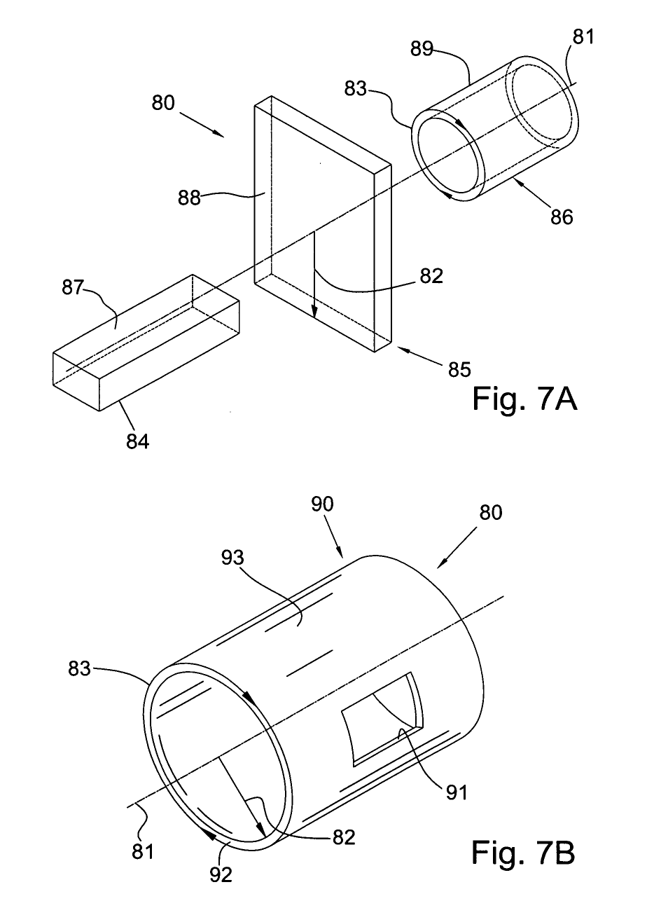

FIG. 7A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 7B is a perspective view of object 90 in cylindrical coordinate system 80 of FIG. 7A demonstrating spatial terminology used in the present application. Cylindrical object 90 is representative of a cylindrical object in a cylindrical coordinate system and is not intended to limit the present invention is any manner. Object 90 includes axial surface 91, radial surface 92, and circumferential surface 93. Surface 91 is part of an axial plane, surface 92 is part of a radial plane, and surface 93 is part of a circumferential plane.

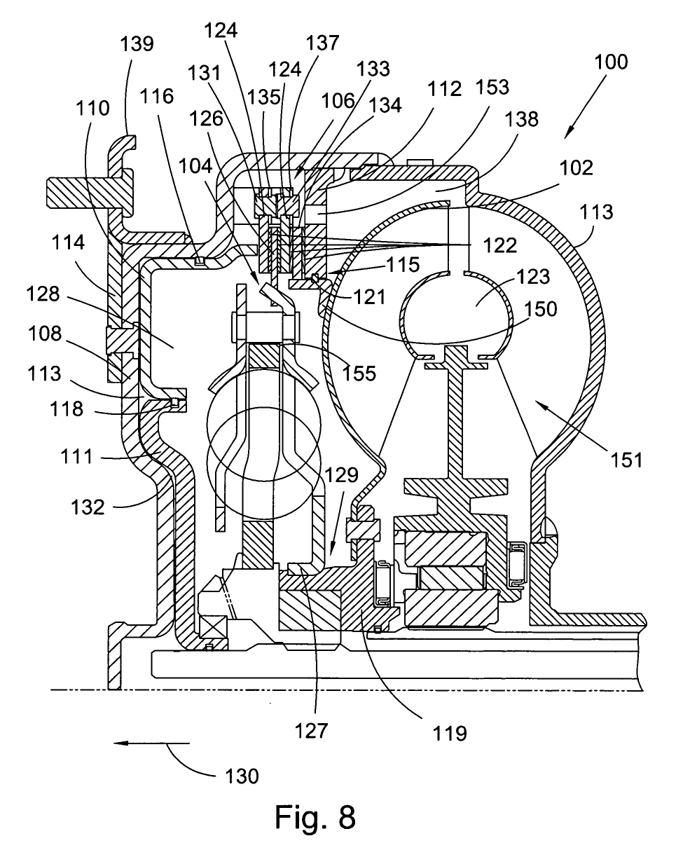

FIG. 8 is a partial cross-sectional view of present invention torque converter 100 with torque converter clutch 106 rotationally connected to turbine shell 102. Damper 104 is rotationally connected to the clutch and to turbine hub 119. By rotationally connected, or secured, we mean that the turbine and the damper are connected such that the two components rotate together, that is, the two components are fixed with respect to rotation. Rotationally connecting two components does not necessarily limit relative movement in other directions. For example, it is possible for two components that are rotationally connected to have axial movement with respect to each other via a spline connection. However, it should be understood that rotational connection does not imply that movement in other directions is necessarily present. For example, two components that are rotationally connected can be axially fixed one to the other. The preceding explanation of rotational connection is applicable to the discussions infra.

Torque converter 100 further includes cover 108, piston plate 110, cover sealing plate 111 and backing plate 112. Cover 108, piston plate 110, and cover sealing plate 111 form apply pressure chamber 113 which is sealed by seals 116 and 118. Seals 116 and 118 prevent fluid loss during lock-up engagement. The operation of chamber 113 is independent from other chambers in torque converter 100, as further described infra.

Backing plate 112 is an annular plate fixed to an inside surface of cover 108. In some aspects (not shown), backing plate 112 is fixed to an inside surface of pump shell 113. In a preferred embodiment, backing plate 112 is welded to cover 108 and extends radially inward with slot 115 at the inside radius of backing plate 112. Carrier, or turbine connection means, 150 is rotationally connected to the turbine shell. In some aspects, carrier 150 is fixed to turbine shell 102 by welding, riveting, or any other attachment means known in the art. Seal 121 is disposed in slot 115 and extends inwards from the slot to the carrier. Seal 121 is a dynamic seal so that the carrier and backing plate 112 can rotate at different speeds as is necessary during torque converter mode, or torque multiplication.

The clutch includes friction plates 124, rotationally connected to the cover, friction plate 126 rotationally connected to cover plate 127 of the damper, and friction plate 134 rotationally connected to carrier 150. The clutch also includes friction material 122. Any type of friction material known in the art can be used. The friction material can be configured in any manner known in the art. For example, the friction material can be fastened to another component, such as friction plate 134, or can be separate elements that are disposed between other components, such as friction plates 124.

During lock-up mode for the torque converter, for example, when clutch 106 is closed, clutch 106 is arranged to transmit torque to turbine hub 119 via carrier 150 and turbine shell 102. The torque from the clutch ‘preloads’ the turbine hub, eliminating the vibration and noise problem noted supra. That is, carrier 150 transmits engine torque to the turbine hub, which otherwise is carrying little or no torque, locking connection 129, typically a spline connection, between cover plate 127 and the turbine hub. That is, contact between the plate and the hub is maintained in the spline connection. The connection of a torque converter clutch and a damper to a turbine hub is further described in commonly-owned U.S. Provisional Patent Application No. 60/816,932, filed Jun. 28, 2006, which is incorporated by reference herein.

Chamber 138 is in fluid communication with torus 123 and chamber 128. When the clutch is open, cooling fluid (not shown) flows from chamber 128, between the friction material to chamber 138 and the torus, providing a cooling flow for the torus. When the clutch is closed, the cooling fluid is arranged to flow from pressure chamber 128 through the friction material, for example, through grooves in the friction material, to chamber 138 and the torus. In some aspects, the cooling flow is reversed, that is, the cooling fluid flows from the torus to chamber 138 to chamber 128. Thus, torque converter 100 provides an advantageous cooling flow through the friction material, enhancing the performance and durability of the friction material, while continuing to supply cooling flow to the torus. In some aspects, backing plate 112 includes orifice 153 arranged to enable a flow of cooling fluid from chamber 128 through the friction material to chamber 138 and the torus. For example, the orifice provides a dimensionally stable passageway for the flow.

The operation of chamber 113, the apply pressure chamber for the clutch, is independent of the operation of chambers 128 and 138. Specifically, the charging and venting of chamber 113, and hence the operation of clutch 106 is performed independent of the pressure and cooling fluid flow through chambers 128 and 138 and the torus. For example, chamber 113 is charged without interrupting the pressure in chambers 128 and 138, since chamber 113 is independently supplied with cooling fluid through channel 132. Therefore, chamber 128 continues to provide cooling fluid through the clutch friction material to chamber 138 and the torus during lock-up mode.

Friction plates 124 are connected to cover 108 by any means known in the art. In some aspects, fasteners 131 and 133 are used to connect the plates to springs 135 and 137, respectively. Any fastener known in the art can be used, including, but not limited to rivets. The springs are fixed to cover 108 and transmit engine torque from the cover to the respective friction plates. The cover is connected to an engine or flexplate (not shown), by any means known in the art, for example, drive plate 139. In some aspects (not shown), a spline arrangement is used to connect plates 124. Advantageously, the use of a spring connection instead of a spline connection reduces undesirable vibration that is inherent in the use of the spline connection.

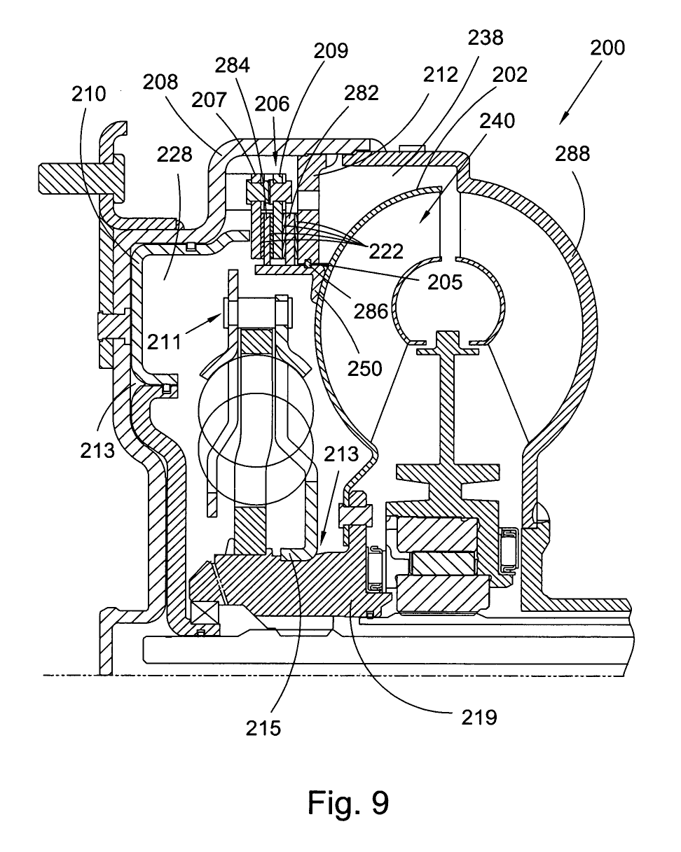

FIG. 9 is a partial cross-sectional view of present invention torque converter 200 with turbine 240 rotationally connected to clutch 206 through friction plates 282 and 284 and carrier 250. In some aspects, carrier 250 is fixedly secured to turbine shell 202 by welding or any other connection means. Backing plate 212 is an annular plate fixed to an inside surface of cover 208. In some aspects (not shown), backing plate 212 is fixed to an inside surface of pump shell 288. In a preferred embodiment, backing plate 212 is welded to cover 208 and extends radially inward with slot 205 at the inside radius of backing plate 212. Seal 286 is disposed in slot 205 and extends inwards from the slot to the carrier. Seal 286 is a dynamic seal so that the carrier and backing plate 212 can rotate at different speeds as is necessary during torque converter mode, or torque multiplication.

The clutch also includes friction plates 207 and 209, rotationally connected to cover 208. There is no direct connection between clutch 206 and damper 211. Therefore, in lock-up mode for the torque converter, that is, when the clutch is closed, all the engine torque transferred from the cover to the clutch is transferred to damper 211 through carrier 250, turbine shell 202, turbine hub 219, and cover plate 215 of the damper. Since all the engine torque passes through the turbine shell to the cover plate, the vibration and noise problem noted supra is eliminated. That is, carrier 250 transmits engine torque to the turbine hub, which otherwise is carrying little or no torque, locking connection 213, typically a spline connection, between cover plate 215 and the turbine hub. That is, contact between the plate and the hub is maintained in the spline connection. The connection of a torque converter clutch and a damper to a turbine hub is further described in commonly-owned U.S. Provisional Patent Application No. 60/816,932, filed Jun. 28, 2006, which is incorporated by reference herein.

The discussion in the description of FIG. 8 regarding friction material 122 is applicable to friction material 222. The discussion in the description of FIG. 8 regarding pressure chambers 113, 128, and 138 is applicable to chambers 213, 228 and 238. The discussion in the description of FIG. 8 regarding the connection of plates 124 to the cover is applicable to plates 207 and 209.

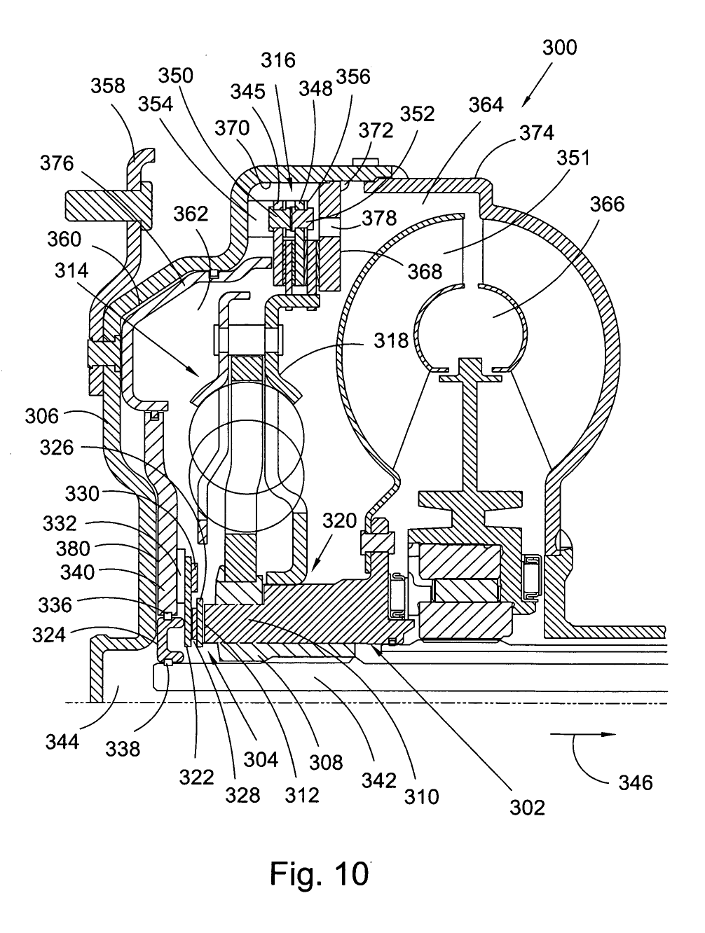

FIG. 10 is a partial cross-sectional view of present invention torque converter 300 with a hub clutch. Converter 300 includes turbine hub 302 and hub clutch device 304 arranged to rotationally connect the turbine hub and cover 306. Torque converter 300 also includes damper hub 308. Turbine hub 302 includes at least one axial extension 310 disposed in a respective opening in the damper hub. That is, hub 302 is formed with one or more sections that extend through respective openings in hub 308. Hub 302 is not limited to any particular size, shape, number, or configuration of axial extensions 310 and the openings in hub 308 are likewise not limited to any particular size, shape, number, or configuration, except as needed to accommodate the axial extensions. As is known in the art, hubs 302 and 308 are rotationally connected, for example, by a spline/tooth arrangement that enables a desired amount of lash between the hubs. Extension 310 is rotationally independent of hub 308. That is, the extension is free to rotate within the openings in hub 308 given the constraints imposed by the spline/tooth arrangement noted above. Extension 310 includes distal end 312 arranged to engage the clutch device. In some aspects, end 312 extends axially beyond hub 308 toward the cover.

The torque converter also includes damper device 314 rotationally connected to torque converter clutch 316 and to damper hub 308. The damper device includes cover plate 318 rotationally connected to the clutch and rotationally connected to the turbine hub with spline connection 320. As noted supra, in lock-up mode for converter 300, turbine 351 may vibrate, or rattle, unless a torque load is applied to the turbine hub. Therefore, in lock-up mode, clutch element 304 is engaged as described infra to rotationally connect cover 306 and hub 302. Advantageously, element 304 transfers engine torque from the cover to the turbine hub via extension 310, which ‘preloads’ the turbine hub, eliminating the vibration and noise problem noted supra. That is, clutch device 304 transmits engine torque to the turbine hub, which otherwise is carrying little or no torque, locking spline connection 320 between plate 318 and hub 302. That is, contact between the plate and the hub is maintained in the spline connection. The connection of a torque converter clutch to a turbine hub is further described in commonly-owned U.S. Provisional Patent Application No. 60/816,932, filed Jun. 28, 2006, which is incorporated by reference herein.

Clutch element 304 includes friction plate 322 connected to cover 306 through plate 340, piston plate 324, friction plate 326 disposed between friction plate 322 and the turbine hub, and friction material 328 disposed between the friction plates. The friction material can be any material known in the art and can be configured in any manner known in the art. For example, the friction material can be fastened to one of friction plates 322 and 326, or can be a separate element disposed between the friction plates. Friction plate 322 is connected to cover 306 by any means known in the art.

In some aspects, fastener 330 is used to connect the plate to spring 332. Any fastener known in the art can be used, including, but not limited to rivets. The spring is fixed to cover 306 and transmits engine torque from the cover to the friction plate. In some aspects (not shown), a spline arrangement is used to connect plate 322 to the cover. Advantageously, the use of a spring connection instead of a spline connection reduces undesirable vibration that is inherent in the use of the spline connection. Plate 326 is centered on damper hub 308, and when clutch device 304 is open, for example, in torque converter mode for the torque converter, is rotationally independent of other components in the torque converter. The preceding arrangement reduces damper friction associated with plate 326. It should be understood that clutch device 304 is not limited to the number, size, and configuration of components shown and that other numbers, sizes, and configurations of components are included in the spirit and scope of the claimed invention.

In lock-up mode, piston 324 is arranged to displace friction plate 322 toward the turbine hub to engage the friction plates, the friction material, and the turbine hub. Piston plate 324 can be controlled by any means known in the art. In some aspects, seals 336 and 338 are used to slidingly seal piston 324 with respect to sealing plate 340 and input shaft 342, respectively, forming a portion of apply chamber 344. Then, to activate device 304, fluid pressure in chamber 344 is increased using any means known in the art, displacing the piston in direction 346 and causing the engagement of the friction plates, friction material, and turbine hub as noted supra.

In torque converter mode for converter 300, it is not desirable to transmit engine torque through device 304 to the turbine hub. Therefore, in torque converter mode, the pressure urging piston 324 in direction 346 is relieved, for example, the pressure in chamber 344 is reduced, opening the clutch device and causing the friction plates, friction material, and turbine hub to rotationally disconnect.

Because of the spline/tooth connection between hubs 302 and 308, the distal radial surface for end 310 includes a plurality of radial extensions. Directly engaging such a surface with friction material creates problems for both the surface and the friction material. Therefore, plate 326 is used to present a uniform and continuous surface with which friction material 328 can engage.

Friction plates 345 and 348 of clutch 316 are connected to cover 306 by any means known in the art. In some aspects, fasteners 350 and 352 are used to connect the plates to springs 354 and 356, respectively. Any fastener known in the art can be used, including, but not limited to rivets. The springs are fixed to cover 306 and transmit engine torque from the cover to the respective friction plates. The cover is connected to an engine or flexplate (not shown), by any means known in the art, for example, drive plate 358. In some aspects (not shown), a spline arrangement is used to connect plates 345 and 348 to the cover. Advantageously, the use of a spring connection instead of a spline connection reduces undesirable vibration that is inherent in the use of the spline connection.

Torque converter 300 also includes apply pressure chamber 360 for clutch 316, pressure chambers 362 and 364, and torus 366. Chamber 364 is in fluid communication with chamber 362 and the torus. When clutch 316 is open, cooling fluid (not shown) flows from chamber 362, between the friction material of the clutch to chamber 364 and the torus, providing a cooling flow for the torus. When the clutch is closed, the cooling fluid is arranged to flow from pressure chamber 362 through the friction material, for example, through grooves in the friction material, to the pressure chamber 364 and the torus. In some aspects, the cooling flow is reversed, that is, the cooling fluid flows from the torus to chamber 364 to chamber 362. Thus, torque converter 300 provides an advantageous cooling flow through the friction material, enhancing the performance and durability of the friction material, while continuing to supply cooling flow to the torus.

Backing plate 368 is fixedly secured to inside surface 370 of cover 306 by any means known in the art, for example, weld 372. In some aspects (not shown), the backing plate is connected to an inside surface of pump shell 374. Plate 368 transmits torque from the cover to clutch 316 and also reacts the pressure applied by plate 376 to close the clutch. In some aspects plate 368 includes orifice 378 arranged to enable a flow of cooling fluid from chamber 362 through the friction material to chamber 364 and the torus. For example, the orifice provides a dimensionally stable passageway for the flow.

The operation of chamber 360 is independent of the operation of chambers 362 and 364. Specifically, the charging and venting of chamber 360, and hence the operation of clutch 316 is performed independent of the pressure and cooling fluid flow through chambers 362 and 364 and the torus. For example, chamber 360 is charged without interrupting the pressure is chambers 362 and 364, since chamber 360 is independently supplied with cooling fluid through channel 380. Therefore, chamber 362 continues to provide cooling fluid through the clutch friction material to chamber 364 and the torus during lock-up mode.

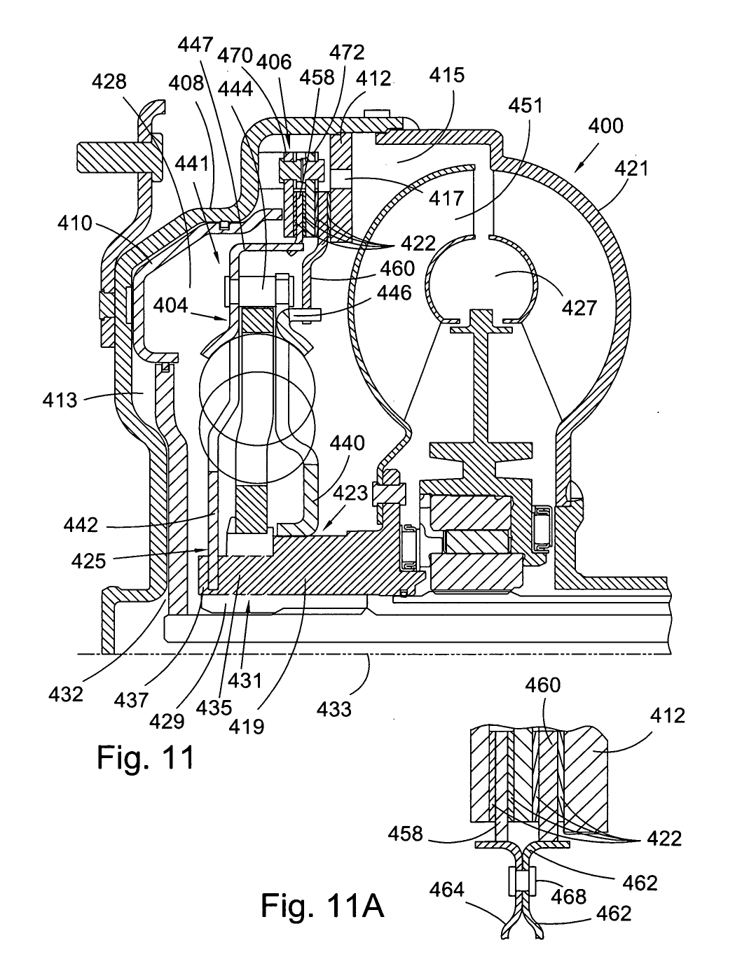

FIG. 11 is a partial cross-sectional view of present invention torque converter 400 with a dual cover plate connection between torque converter clutch 406 and damper 404.

FIG. 11A is a detail view of an alternative clutch plate applicable to the torque converter shown in FIG. 11. The following should be viewed in light of FIGS. 11 and 11A. Torque converter 400 further includes cover 408, piston plate 410, and backing plate 412. Cover 408 and piston plate 410 partially form apply pressure chamber 413 which is sealed from chambers 415 and 428.

Backing plate 412 is fixedly secured to and inside surface of cover 408 by any means known in the art, for example, welding. In some aspects (not shown), the backing plate is connected to an inside surface of pump shell 421. Plate 412 transmits torque from the cover to clutch 406 and also reacts the pressure applied by plate 410 to close the clutch. In some aspects plate 412 includes orifice 417 arranged to enable a flow of cooling fluid from chamber 428 through friction material 422 of the clutch to chamber 415 and torus 427. For example, the orifice provides a dimensionally stable passageway for the flow.

Damper 404 includes cover plates 440 and 442, rotationally connected to friction plates 458 and 460 of the clutch. In some aspects, plate 442 includes segment 447 which is connected to plate 458 with a spline connection. In some aspects (not shown), segment 447 is a separate plate connected to plate 442. In some aspects, connection element 446 rotationally connects cover plate 440 and engagement plate 460. In some aspects, element 446 is integral to plate 440. In some aspects (not shown), element 446 is separate from plate 440 and connected to plate 440 with a spline connection. Cover plates 440 and 442 are axially coupled to one another via rivet 444. In some aspects, cover plate 440 is at least partially rotationally independent of the cover plate 442. That is, a limited amount of relative rotation between the cover plates is possible. In some aspects, rivet 444 passes through slot 441 in cover plate 442 and is fixedly secured to cover plate 440. The slot is circumferentially oriented and enables a limited circumferential movement of the rivet within the slot. It should be understood that this configuration can be reversed, that is, the slot can be placed in plate 440 and the rivet fixed to plate 442. The relative rotation of the cover plates is used to accommodate the lash present in spline connections 423 and 425 of plates 440 and 442 respectively, to hub 419 and to accommodate the difference in circumferential movement between the cover plates at the respective splines due to the different radial distances of the splines from axis 433 of the torque converter.

Damper assembly 404 is rotationally connected to damper hub 429. The damper hub includes at least one opening 431 and turbine hub 419 includes at least one portion 435 disposed in the opening and having distal portion 437 extending axially beyond the damper hub toward cover 408. Cover plate 442 is rotationally connected to the distal portion.

As noted supra, in lock-up mode for converter 400, turbine 451 may vibrate, or rattle, unless a torque load is applied to the turbine hub. Therefore, in lock-up mode, plate 442 transfers engine torque from the clutch to the turbine hub, which ‘preloads’ the turbine hub, eliminating the vibration and noise problem noted supra. That is, plate 442 transmits engine torque to the turbine hub, which otherwise is carrying little or no torque, locking spline connection 423. That is, contact between the plate and the hub is maintained in the spline connection. The connection of a torque converter clutch to a turbine hub is further described in commonly-owned U.S. Provisional Patent Application No. 60/816,932, filed Jun. 28, 2006, which is incorporated by reference herein.

The clutch also includes friction material 422. Any type of friction material known in the art can be used. The friction material can be configured in any manner known in the art. For example, the friction material can be fastened to another component, such as a friction plate, or can be separate elements that are disposed between other components, such as friction plates.

Chamber 415 is in fluid communication with chamber 428 and the torus. When clutch 406 is open, cooling fluid (not shown) flows from chamber 428, between the friction material of the clutch to chamber 415 and the torus, providing a cooling flow for the torus. When the clutch is closed, the cooling fluid is arranged to flow from pressure chamber 428 through the friction material, for example, through grooves in the friction material, to the pressure chamber 415 and the torus. In some aspects, the cooling flow is reversed, that is, the cooling fluid flows from the torus to chamber 415 to chamber 458. Thus, torque converter 400 provides an advantageous cooling flow through the friction material, enhancing the performance and durability of the friction material, while continuing to supply cooling flow to the torus.

The operation of chamber 413 is independent of the operation of chambers 428 and 415. Specifically, the charging and venting of chamber 413, and hence the operation of clutch 406 is performed independent of the pressure and cooling fluid flow through chambers 428 and 415 and the torus. For example, chamber 413 is charged without interrupting the pressure is chambers 428 and 415, since chamber 413 is independently supplied with cooling fluid through channel 432. Therefore, chamber 428 continues to provide cooling fluid through the clutch friction material to chamber 415 and the torus during lock-up mode. The discussion in the description of FIG. 10 regarding the connection of plates 346 and 348 to the cover is applicable to plates 470 and 472 in clutch 406.

FIG. 11A shows an alternative connection means for damper cover plates to the torque converter clutch. Cover plates 462 and 464, analogous to plates 440 and 442, are joined by rivet 468, analogous to rivet 444. In the arrangement of FIG. 11A, the clutch and the damper are substantially radially aligned and cover plates 462 and 464 are brought into direct contact, or are only separated by relatively small intermediate parts (not shown). In some aspects, there is limited relative rotation between cover plates 462 and 464 and the discussion regarding the relative motion of plates 440 and 442 is applicable to plate 462 and 464.

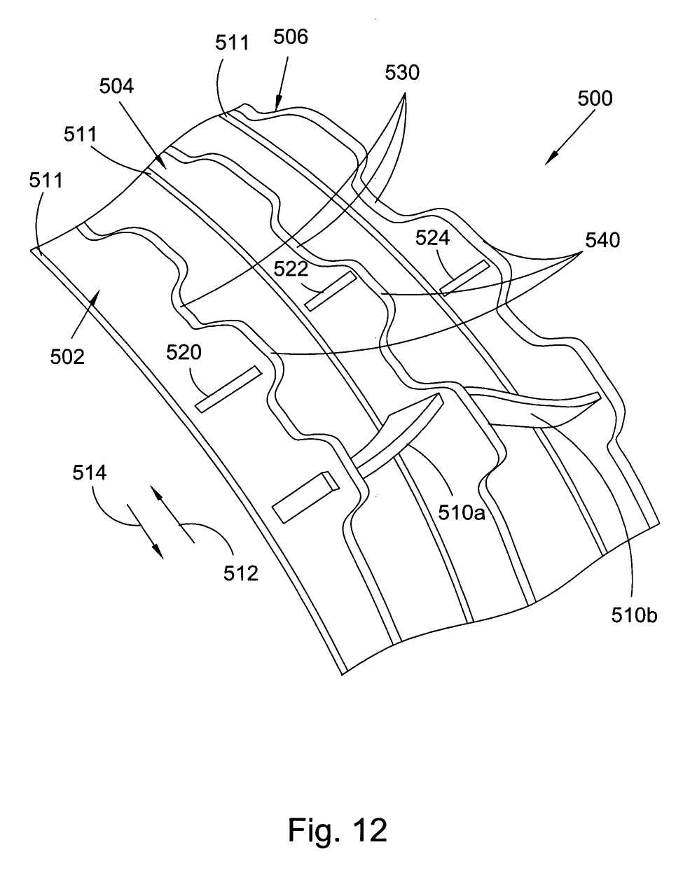

FIG. 12 is a partial perspective view of a present invention torque converter anti-rattle connection. Clutch plate arrangement 500 includes three or more plates rotationally engaged with a carrier (not shown) or a cover (not shown) through a spline connection (not shown). Clutch, or friction, plates 502, 504, and 506 each include spaces 530 and teeth 540 for rotational engagement with the carrier spline connection. In some aspects, clutch plates 502, 504, and 506 have friction material attached to one or both sides of each clutch plate for frictional engagement. In some aspects, the friction plates are separate elements placed between the clutch plates. Arrangement 500 also includes friction material 511 connected to the friction plates and/or separately disposed between the friction plates.

Clutch plate 502 has one or more slots 520, clutch plate 504 has one or more slots 522, and clutch plate 506 has one or more respective slots 524. In some aspects, slots 520, 522, and 524 are offset circumferentially within each respective tooth 540 so that when the teeth are axially aligned, each slot is axially offset with respect to the immediately axially proximate slot. For example, slot 520 is offset with respect to slot 522. In the same manner, slot 522 is offset with respect to slot 524. In some aspects, slots 520 and 524 may be aligned so long as intervening slot 522 is offset with respect to both slots 520 and 524. Resilient elements 510 are engaged with respective clutch plates, for example through the respective slots, and are arranged to urge the respective clutch plates in opposite circumferential directions. For example, element 510a urges plate 504 in direction 512 and plate 502 in direction 514. In like manner, element 510b urges plate 504 in direction 512 and plate 506 in direction 514. That is, elements 510 are preloaded when installed in arrangement 500 to create the circumferential forces described supra. It should be understood that these directions can be reversed. Thus, circumferential force, from elements 510, on each slot ‘pre-load’ clutch plates 502, 504, and 506 at the mating spline in opposing directions due to the preload force from spring elements 510 attempting to overcome the offset position. That is, elements 510 force teeth 540 to remain in contact with the carrier spline connection, eliminating rattle and vibration problems due to lash in the spline connection. It should be understood that elements 510 can be a single resilient element. Elements 510 can be any resilient element known in the art, for example, springs. It should be understood that arrangement 500 is not limited to any particular number of slots or resilient elements.

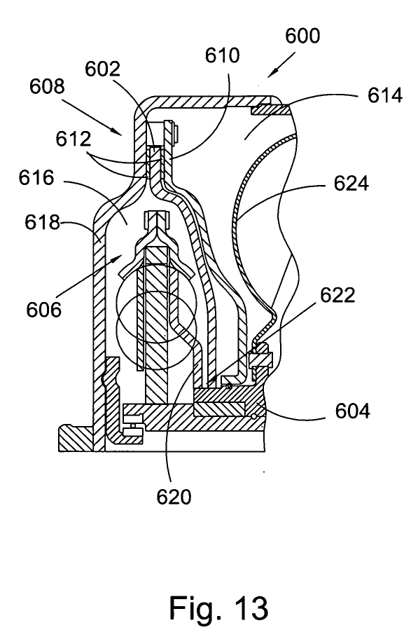

FIG. 13 is a partial cross-sectional view of present invention torque converter 600 with anti-rattle plate 602. Torque converter 600 includes turbine hub 604, damper 606 rotationally connected to the turbine hub, and torque converter clutch 608. The clutch includes piston plate 610 rotationally connected to turbine hub 604, friction, clutch, or anti-rattle, plate 602 rotationally connected to turbine hub 604, and friction material 612. Any type of friction material known in the art can be used. The friction material can be configured in any manner known in the art. For example, the friction material can be fastened to another component, such as friction plate 602, or can be separate elements that are disposed between other components, such as friction plate 602 and piston plate 610.

During lock-up mode for the torque converter, fluid pressure in chamber 614 is greater than fluid pressure in chamber 616. The pressure in chamber 614 creates axial movement of piston plate 610 towards cover 618, rotationally connecting the cover, the friction plate, the piston plate, and the friction material, closing the clutch. In some aspect, cooling fluid flows from chamber 614 through grooves (not shown) in friction material 612 to chamber 616.

As noted supra, in lock-up mode for converter 600, cover plate 620, which is rotationally connected to hub 604, for example, by spline connection 622, may vibrate, or rattle, unless a torque load is applied to the turbine hub. Therefore, in lock-up mode, torque is transmitted from cover 618 to damper 606 through plate 602 to hub 604 to cover plate 620, which ‘preloads’ the turbine hub, eliminating the vibration and noise problem noted supra. That is, all the engine torque from the cover passes through plate 602 to the hub, which otherwise is carrying little or no torque, locking spline connection 622. That is, contact between the plate and the hub is maintained in the spline connection. The connection of a torque converter clutch to a turbine hub is further described in commonly-owned U.S. Provisional Patent Application No. 60/816,932, filed Jun. 28, 2006, which is incorporated by reference herein.

During torque converter mode, torque from turbine 624 is transferred directly to hub 604 and through plate 620 to the damper.

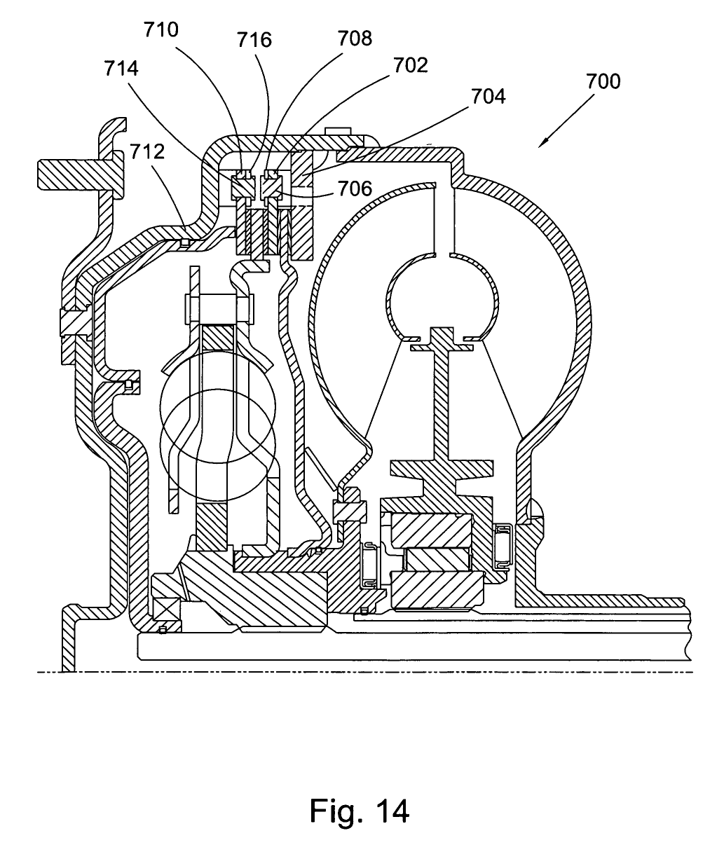

FIG. 14 is a partial cross-sectional view of present invention torque converter 700 with friction plate 702 connected to backing plate 704. Except as described below, the configuration of torque converter 700 is substantially the same as that shown for a torque converter in commonly-owned U.S. Provisional Patent Application No. 60/816,932, filed Jun. 28, 2006, which is incorporated by reference herein. In converter 700, friction plate 702 is rotationally connected to backing plate 704 by any means known in the art. In some aspects, fastener 706 is used to fixedly secure the plate to leaf spring 708 and the backing plate. Friction plate 710 is rotationally connected to cover 712 by any means known in the art. In some aspects, fastener 714 is used to fixedly secure the plate to leaf spring 716 and the cover. Fasteners 706 and 714 can be any fastener known in the art, for example, a rivet. In some aspects (not shown), respective spline connections are used to connect plate 702 or plate 710 to the backing plate or cover, respectively.

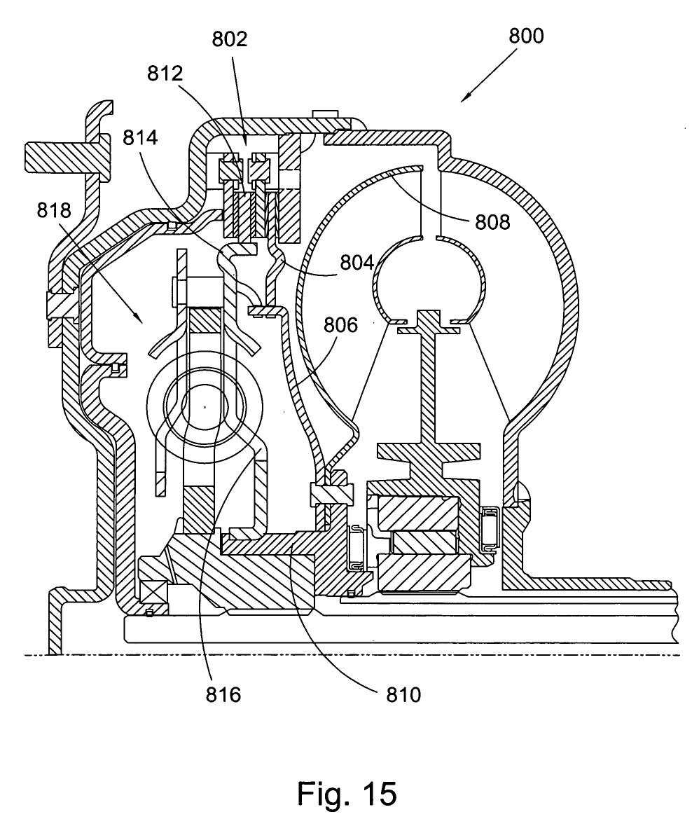

FIG. 15 is a partial cross-sectional view of present invention torque converter 800 with friction plate 802 connected to backing plate 804. The configuration of torque converter 800 is substantially the same as that of torque converter 800 in FIG. 14, except as noted below. In torque converter clutch 802, friction plate 804 is rotationally connected to plate 806, which is fixedly secured to turbine shell 808 and turbine hub 810. Friction plate 812 is connected to connector plate 814. Plate 814 is rotationally connected to cover plate 816 of damper 818 and also to plate 806. In some aspects, the connections between plate 806 and plates 804 and 814 are spline connections. In some aspects, plate 814 is integral to plate 816. In some aspects (not shown), plate 814 is separate from plate 816 and rotationally connected to plate 816.

In torque converter mode for converter 800, torque is transmitted from the turbine shell to the damper via plates 806 and 814. As noted supra, in lock-up mode for converter 800, the turbine 808 may vibrate, or rattle, due to lash at the connection of plate 816 with turbine hub 810 unless a torque load is applied to the turbine hub, or specifically to the connection. Therefore, in lock-up mode, plate 804 transfers engine torque from the clutch to plate 806, which ‘preloads’ the plate 806, eliminating the vibration and noise problem noted supra. That is, plate 804 transmits engine torque to plate 806, which otherwise is carrying little or no torque, locking the spline connection between plates 806 and 814. That is, contact between the plates is maintained in the spline connection. The connection of a torque converter clutch to a turbine hub is further described in commonly-owned U.S. Provisional Patent Application No. 60/816,932, filed Jun. 28, 2006, which is incorporated by reference herein.

It should be understood that a present invention torque converter is not limited to the type, size, number, or configuration of components shown in the figures and that other types, sizes, numbers, or configurations of components are included in the spirit and scope of the claimed invention. For example, a present invention torque converter is not limited to the use of a torque converter clutch or damper with the configurations shown in the figures and that other types of components and numbers, sizes, and configurations of components for a torque converter clutch or damper are included in the spirit and scope of the claimed invention.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A torque converter comprising:
a carrier for a torque converter clutch, the carrier rotationally connected to a turbine shell;
an apply chamber for the clutch; and,
a first pressure chamber in fluid communication with a second pressure chamber and a torus, wherein pressure in the apply chamber is controlled independent of pressure in the first and second pressure chambers.

2. The torque converter of claim 1 wherein the carrier is fixedly secured to the turbine shell.

3. The torque converter of claim 1 including a turbine hub rotationally connected to the turbine shell.

4. The torque converter of claim 3 including a damper with a cover plate and wherein the clutch includes a friction plate rotationally connected to the cover plate.

5. The torque converter of claim 4 wherein the cover plate is rotationally connected to the turbine hub.

6. The torque converter of claim 5 wherein when the clutch is closed, a first torque transfer path is formed from the clutch to the turbine hub through the carrier and the turbine shell and a second torque transfer path is formed from the clutch to the turbine hub through the cover plate.

7. The torque converter of claim 3 further comprising a cover arranged to transmit torque to the clutch and wherein when the clutch is closed, substantially all of the torque is transferred from the clutch to the turbine hub through the turbine shell.

8. The torque converter of claim 7 including a damper with a cover plate rotationally connected to the turbine hub.

9. A torque converter comprising:
a turbine hub rotationally connected to a turbine shell and a cover plate for a damper assembly; and,
a hub clutch arranged to rotationally connect the turbine hub to a cover.

10. The torque converter of claim 9 including a torque converter clutch rotationally connected to the cover plate.

11. The torque converter of claim 10 wherein the cover is rotationally connected to the torque converter clutch and wherein when the torque converter clutch is closed, the hub clutch is arranged to close, a first torque path is formed from the cover through the hub clutch to the turbine hub and a second torque path is formed from the cover to the turbine hub through the torque converter clutch and the cover plate.

12. The torque converter of claim 9 including a damper hub rotationally connected to the damper assembly, the damper hub including at least one opening and wherein the turbine hub includes at least one portion disposed in the at least one opening and having a distal end arranged to engage the hub clutch.

13. The torque converter of claim 9 wherein the hub clutch includes a drive plate rotationally connected to the cover and a piston plate arranged to urge the drive plate toward the turbine hub to rotationally connect the cover and the turbine hub.

14. The torque converter of claim 9 including:
an apply chamber for a torque converter clutch; and,
a first pressure chamber in fluid communication with a second pressure chamber and a torus, wherein pressure in the apply chamber is controlled independent of pressure in the first and second pressure chambers.

15. A torque converter including:
a first cover plate for a damper assembly, the first cover plate rotationally connected to a turbine hub and a torque converter clutch; and,
a second cover plate for a damper assembly, the second cover plate rotationally connected to the turbine hub and the torque converter clutch.

16. The torque converter of claim 15 wherein the clutch includes a first friction plate rotationally connected to the first cover plate and a second friction plate rotationally connected to the second cover plate.

17. The torque converter of claim 15 wherein the first cover plate is at least partially rotationally independent of the second cover plate.

18. The torque converter of claim 15 including a cover and a damper hub rotationally connected to the damper assembly, the damper hub including at least one opening, wherein the turbine hub includes at least one portion disposed in the at least one opening and having a distal portion extending axially beyond the damper hub toward the cover and wherein the second cover plate is rotationally connected to the distal portion.

19. The torque converter of claim 15 including a turbine shell and wherein in a torque converter mode for the torque converter, the turbine shell is arranged to transmit torque to the damper through the turbine hub and the first and second cover plates.

20. The torque converter of claim 19 wherein when the torque converter clutch is closed, a first torque path is formed from the clutch to the turbine hub through the first cover plate and a second torque path is formed from the clutch to the turbine hub through the second cover plate.

21. The torque converter of claim 15 including:
an apply chamber for the torque converter clutch; and,
a first pressure chamber in fluid communication with a second pressure chamber and a torus, wherein pressure in the apply chamber is controlled independent of pressure in the first and second pressure chambers.

22. A torque converter including:
a turbine hub;
a cover plate for a damper assembly, the cover plate rotationally connected to the turbine hub;
a friction plate for a torque converter clutch, the friction plate rotationally connected to the turbine hub; and,
a piston plate for the torque converter clutch, wherein in a torque converter mode for the torque converter, a turbine shell is arranged to transmit torque to the damper through the turbine hub and the cover plate, wherein when the clutch is closed, the clutch is arranged to transmit torque to the damper through the friction plate, the turbine hub, and the cover plate, and wherein the piston plate is arranged to displace toward a cover to engage the torque converter clutch.

23. A torque converter including:
a carrier for a torque converter clutch;
first, second, and third clutch plates rotationally connected to the carrier;
a first resilient element engaged with the first and second clutch plates and arranged to urge the first and second clutch plates in opposite circumferential directions; and,
a second resilient element engaged with the second and third clutch plates and arranged to urge the second and third clutch plates in opposite circumferential directions.

24. The torque converter of claim 23 wherein the carrier includes a spline, wherein the first, second, and third clutch plates are rotationally connected to the spline, and wherein the first and second resilient elements are arranged to urge the first, second, and third clutch plates against the spline.

25. A torque converter including:
a first clutch plate for a torque converter clutch, the first clutch plate rotationally connected to a cover; and,
a second clutch plate for the torque converter clutch, the second clutch plate rotationally connected to a backing plate.

26. The torque converter of claim 25 including a turbine hub rotationally connected to a cover plate for a damper and a turbine shell and wherein the torque converter clutch includes a third clutch plate rotationally connected to the turbine hub.

27. The torque converter of claim 25 including a turbine hub rotationally connected to a turbine shell and wherein the torque converter clutch includes a fourth clutch plate rotationally connected to the turbine hub.

28. The torque converter of claim 27 including a plate, a connector plate, and a cover plate for a damper, wherein the clutch includes a fifth clutch plate, wherein the plate is rotationally connected to the fourth clutch plate and the turbine hub and the connection plate is rotationally connected to the plate, the cover plate and the fifth clutch plate.

29. The torque converter of claim 25 including:
an apply chamber for the torque converter clutch; and,
a first pressure chamber in fluid communication with a second pressure chamber and a torus, wherein pressure in the apply chamber is controlled independent of pressure in the first and second pressure chambers.
